(19) United States
(12) Patent Application Publication
(10) Pub. No.: US 2007/0024885 A1
(43) Pub. Date: Feb. 1, 2007

(54) Apparatus and method for printing plurality of pages on one page in PDF direct printing

(75) Inventor: Yoon-young Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/488,728

(22) Filed: Jul. 19, 2006

(30) Foreign Application Priority Data
Jul. 27, 2005 (KR) 2005-68615

(51) Int. Cl. G06F 3/12

(52) U.S. Cl. 358/1.13; 358/1.15

(57) ABSTRACT

An apparatus and a method of printing a plurality of pages on a single page in a portable document format (PDF) direct printing, the apparatus including: a data input module to receive a PDF document; a user interface to receive an input number of pages to be printed on a single page; a controller arranged to convert the received PDF document to printing data according to the input number of pages; and a printing module to print in PDF direct printing the printing data obtained from the controller corresponding to the input number of pages on a single page. Accordingly, a plurality of pages can be respectively printed on one or more corresponding pages in PDF direct printing as in printing using a printer driver by converting an input PDF document to a PostScript language according to a ratio corresponding to the input number of pages.

### CROSS-REFERENCE TO RELATED APPLICATION

This application claims the benefit of Korean Patent Application No. 2005-68615, filed on Jul. 27, 2005, in the Korean Intellectual Property Office, the disclosure of which is incorporated herein in its entirety by reference.

### BACKGROUND OF THE INVENTION

1. Field of the Invention

Aspects of the invention relate to an apparatus and method of printing a plurality of pages on one page in portable document format (PDF) direct printing, and, more particularly, to an apparatus and method of printing a plurality of pages on one page in PDF direct printing by converting an input PDF document to a PostScript language according to a ratio corresponding to an input number of pages.

2. Description of the Related Art

N-up printing indicates that a plurality of pages are printed on a single page. By way of example, 2-up printing indicates that two pages are printed on one page, and 4-up printing indicates that four pages are printed on one page. While n-up printing in a printer is known using a printer driver, the n-up printing is not supported by direct printing in which printing is performed without a printer driver by directly connecting a portable storage medium, such as a universal serial bus (USB) memory to a printer.

When a portable document format (PDF) document is directly printed using a portable storage medium without using a host computer, the PDF document is typically printed only by converting it to a script document, and a function of printing by selecting an option, such an n-up PDF direct printing is not supported. Thus, a function of selecting an option, such as n-up PDF direct printing, on a user interface such as a liquid crystal display (LCD) panel of a printer, and performing printing according to the selected option is required.

### SUMMARY OF THE INVENTION

Several aspects and example embodiments of the invention provide an apparatus and a method of printing a plurality of pages on one page in portable document format (PDF) direct printing, such as in printing using a printer driver, by converting an input PDF document to a PostScript language, or other suitable language, according to a ratio corresponding to the input number of a plurality of pages. The conversion of the input PDF document to the Post Script language according to the ratio corresponding to the input number of the plurality of pages promotes resolving a disadvantage, namely that an option to PDF direct print a plurality of pages on a single page cannot be selected in direct printing, such as where printing is performed without a printer driver by directly connecting a portable storage medium, such as by connecting a USB memory to a printer.

According to an embodiment and aspect, among aspects, of the invention, there is provided an apparatus to print a plurality of pages on a single page in PDF direct printing, the apparatus including: a data input module to receive a PDF document; a user interface to receive an input number of pages to be printed on the single page; a controller arranged to convert the received PDF document to printing data according to the input number of pages to print a corresponding number of pages of the PDF document on the single page; and a printing module to print in PDF direct printing the printing data obtained from the controller corresponding to the input number of pages on the single page. The apparatus, according to aspects of the invention, may correspond to a printer or to a host computer that communicates with a printer, for example.

The apparatus, according to aspects of the invention, can further include: a memory module to store the received PDF document or the converted printing data. Also, according to aspects of the invention, the controller can include a parser to generate parsing data by parsing the PDF document. Further, according to aspects of the invention, the printing data can be a PostScript language.

The controller, according to aspects of the invention, can further include: a PostScript converter to convert the parsing data to a PostScript language; and an interpreter to generate an interpreted PostScript language by interpreting the PostScript language, wherein the PostScript converter converts the parsing data to the PostScript language by reducing the parsing data by a ratio corresponding to the input number of pages.

The data input module, according to aspects of the invention, can be connected to a portable storage device, such as a universal serial bus (USB) memory, or can communicate with a host computer. Also, the memory module, according to aspects of the invention, can include: a dynamic buffer to store the parsing data generated by the parser; and a parsing buffer to store the PostScript language obtained by the PostScript converter. Further, according to aspects of the invention, the printing module can print the interpreted PostScript language generated by the interpreter of the controller using a kernel.

According to another embodiment and aspect, among aspects, of the invention, there is provided a method of printing a plurality of pages on a single page in PDF direct printing, the method including: receiving a PDF document; inputting a number of pages to be printed on a single page; converting the received PDF document to printing data according to the input number of pages to print a corresponding number of pages of the PDF document on the single page; and printing in PDF direct printing the converted printing data corresponding to the input number of pages on the single page.

The conversion, according to aspects of the invention, can further include generating parsing data by parsing the PDF document. The conversion, according to aspects of the invention, can further include, after the generation of the parsing data, converting the parsing data to a PostScript language by reducing the parsing data by a ratio corresponding to the input number of pages, and generating an interpreted PostScript language by interpreting the PostScript language. The conversion, according to aspects of the invention, can also include storing the parsing data generated in the generation of the parsing data in a dynamic buffer. Further, according to aspects of the invention, the conversion can include storing the PostScript language converted in the conversion of the parsing data in a parsing buffer.

In the receiving of the PDF document, the PDF document, according to aspects of the invention, can be received from a portable storage device, such as from a USB memory, or from a host computer, for example. In the printing, the interpreted PostScript language generated in the generation of the interpreted PostScript language, according to aspects of the invention, can be printed in a kernel.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus to print a plurality of pages on one page in PDF direct printing according to an embodiment and aspects of the invention; and

FIG. 2 is a flowchart illustrating a method of printing a plurality of pages on one page in PDF direct printing according to an embodiment and aspects of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

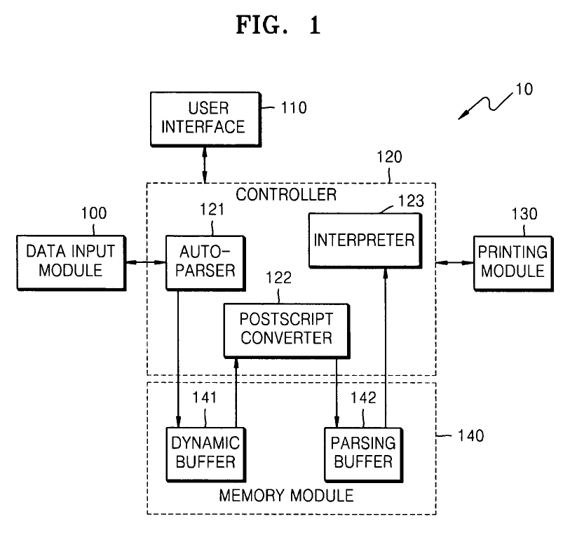

FIG. 1 is a block diagram of an apparatus 10 to print a plurality of pages on a single page in PDF direct printing according to an embodiment and aspects of the invention. Referring to FIG. 1, the apparatus 10 includes a data input module 100, a user interface 110, a controller 120, a printing module 130, and a memory module 140. The apparatus 10 may correspond to a printer provided with suitable firmware and/or software. Alternatively, selected components of the apparatus 10 can be incorporated into a host computer to control PDF direct printing at a printer.

The data input module 100 receives a PDF document. In this regard and by way of example, the data input module 100 is connected to a portable storage device, such as a USB memory, and receives the PDF document from, for example, a USB memory stick in which the PDF document is stored, or the data input module 100 can communicate with a host computer or a wireless network or a wired and/or wireless network to receive the PDF document. Also, the data input module 100 can receive the PDF document stored in various storage devices or storage media, such as read-only memory (ROM), random-access memory (RAM), magnetic storage media (e.g., floppy discs, hard discs, etc.), optical storage media (e.g., compact disc-read only memories (CD-ROMs), digital video discs (DVDs), etc.) and carrier waves (e.g., transmissions over the Internet), or other suitable storage devices or storage media. The number of pages to be printed on a single page is input, via the user interface 110. The user interface 110, by way of example, can include a keypad (not shown), a mouse (not shown) and/or a liquid crystal panel (LCD) panel or other suitable display device (not shown), a touch panel (not shown), a receiver to receive an input from a network, or other suitable user interface.

The controller 120 converts the received PDF document to a PostScript language according to a ratio corresponding to the number of pages, and controls the operations of the apparatus 10. The controller 120 can be, by way of example, a processor, microprocessor, an application specific integrated circuit (ASIC), a field-programmable gate array (FPGA), a module, such as a hardware component or a software component, and can be included in an addressable storage medium or can be configured to execute on one or more processors, with associated memory and software or programming. The controller 120, according to aspects of the invention, typically can include an auto-parser 121, a PostScript converter 122, and an interpreter 123.

As shown in FIG. 1, the auto-parser 121 generates parsing data by dividing the PDF document into meaningful units, such as to convert to a PostScript language, or other suitable language. The PostScript converter 122 converts the parsing data to a PostScript language. In this regard and by way of example, the PostScript converter 122 converts the parsing data to the PostScript language, or other suitable language, by reducing the parsing data by the ratio corresponding to the number of the plurality of pages. The interpreter 123 generates an interpreted PostScript language by interpreting the PostScript language converted by the converter 122.

The printing module 130 prints the printing data obtained from the controller 120 in PDF direct printing corresponding to the input number of pages on a single page. By way of example, the printing module 130 may correspond to a printer or other suitable printing device to print in PDF direct printing the converted printing data. Also, the control module 130 prints the PostScript language, such as according to a control signal of the controller 120. In this regard, the printing module 130 prints the interpreted PostScript language generated by the interpreter 123 in its kernel, such as by an operating system, a program or a software routine.

The memory module 140 temporarily stores the received PDF document and the converted PostScript language. Typically, according to aspects of the invention, the memory module 140 includes a dynamic buffer 141 and a parsing buffer 142. The dynamic buffer 141 stores the parsing data generated by the auto-parser 121. The parsing buffer 142 stores the PostScript language obtained by the PostScript converter 122. By way of example, the memory module 140 can include various suitable memories, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape, and optical media such as compact discs (CDs) or digital video discs (DVDs).

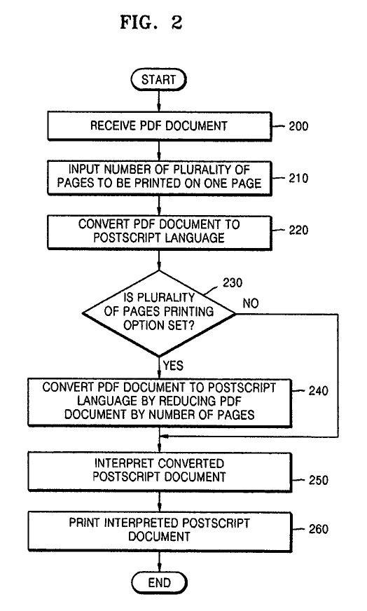

FIG. 2 is a flowchart illustrating a method of printing a plurality of pages on a single page in PDF direct printing according to an embodiment and aspects of the invention, and, by way of example is described in conjunction with FIG. 1. Referring to FIGS. 1 and 2, in operation 200, a PDF document, or PDF documents, stored in a portable storage medium, such as a USB memory stick or other suitable memory, or received from a host computer or a network, is/are input to the data input module 100. In this regard, a user can select, for example, a PDF document, a plurality of pages from one or more PDF documents, or a plurality of PDF documents to be input, such as by using the user interface 110, or other suitable input device or transmission to the apparatus 10.

After the PDF document(s) is/are selected and input to the data input module 100, in operation 210, the user can select an option of printing a number of pages on a single page and input the number of pages to be printed on the single page, such as via the user interface 110. Also, a user can select and input, such as via the user interface 110, at operation 210, for example, one or more groups each of a corresponding number of pages from a plurality of pages from the one or more PDF documents, with each group of a corresponding input number of pages to be printed on a corresponding single page. In operation 220, in converting the PDF document(s) to a PostScript language, the input PDF document(s) is/are converted to parsing data by being divided into meaningful units by the auto-parser 121, temporarily stored in the dynamic buffer 141, and transmitted to the PostScript converter 122, and the PostScript converter 122 converts the parsing data to the PostScript language.

In operation 230, the controller 120 determines whether a printing option of printing a plurality of pages of the PDF document(s) on one page has been selected. If the printing option of printing a plurality of pages on a single page has not been selected in operation 230, the operation proceeds to operation 250. In operation 250, the interpreter 123 generates an interpreted PostScript document by interpreting the converted PostScript language, and, in operation 260, the printing module 130 prints the interpreted PostScript document.

If, in operation 230, the printing option of printing a plurality of pages on a single page has been selected as a result of the determination of the controller 120, the operation proceeds to operation 240. In operation 240, the PostScript converter 122 converts the parsing data to the PostScript language by reducing the parsing data by a ratio corresponding to the input number of pages of each group for each corresponding single page to be printed. In operation 250, the interpreter 123 generates interpreted PostScript document(s) by interpreting the converted PostScript language, and in operation 260, the printing module 130 prints in PDF direct printing the interpreted PostScript document(s) obtained from the controller 120 by printing the plurality of pages of the converted PFD document(s) on each corresponding single page.

The embodiments and aspects of the invention can be written as computer programs and can be implemented in general-use digital computers that execute the programs using a computer readable recording medium. Examples of the computer readable recording medium can include magnetic storage media (e.g., ROM, floppy disks, hard disks, etc.), optical recording media (e.g., CD-ROMs, or DVDs), and storage media such as carrier waves (e.g., transmission through the Internet).

As described above, according to embodiments and aspects of the present invention, a plurality of pages can be printed on a single page in PDF direct printing as in printing using a printer driver by converting an input PDF document to a PostScript language according to a ratio corresponding to the input number of pages to be printed on a corresponding single page.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. For example, the embodiments and aspects of the invention can be implemented as computer programs, and can also be implemented in general-use digital computers, processors and/or microprocessors, that execute the programs using a computer-readable recording medium or media or by using transmission media, such as carrier waves, and/or in conjunction with hardware, firmware and/or software components or modules. Also, the apparatus 10 illustrated in FIG. 1 may correspond to a printer provided with suitable firmware and/or software. Alternatively, selected components of the apparatus 10 can be incorporated into a host computer to control PDF direct printing at a printer. Accordingly, it is intended, therefore, that that present invention not be limited to the various example embodiments disclosed, but that the present invention includes all embodiments falling within the scope of the appended claims.

1: An apparatus to print a plurality of pages on a single page in portable document format (PDF) direct printing, the apparatus comprising:
a data input module to receive a PDF document;
a user interface to receive an input number of pages to be printed on a single page;
a controller arranged to convert the received PDF document to printing data according to the input number of pages to print a corresponding number of pages of the PDF document on the single page; and
a printing module to print in PDF direct printing the printing data obtained from the controller corresponding to the input number of pages on the single page.

2: The apparatus of claim 1, further comprising a memory module to store the received PDF document or the converted printing data.

3: A method of printing a plurality of pages on a single page in portable document format (PDF) direct printing, the method comprising:
receiving a PDF document;
inputting a number of pages to be printed on a single page;
converting the received PDF document to printing data according to the input number of pages to print a corresponding number of pages of the PDF document on the single page; and
printing in PDF direct printing the converted printing data corresponding to the input number of pages on the single page.

4: The method of claim 3, wherein the converting the received PDF document comprises:
generating parsing data by parsing the PDF document;
converting the parsing data to a PostScript language by reducing the parsing data by a ratio corresponding to the input number of pages; and
generating an interpreted PostScript language by interpreting the PostScript language. cm 5: A computer-readable recording medium having computer-executable instructions for performing a method of printing a plurality of pages on a single page in portable document format (PDF) direct printing comprising:
receiving a PDF document;
inputting a number of pages to be printed on a single page;
converting the received PDF document to printing data according to the input number of pages to print a corresponding number of pages of the PDF document on the single page; and
printing in PDF direct printing the converted printing data corresponding to the input number of pages on the single page.

6: A method of printing a plurality of pages on a single page in portable document format (PDF) direct printing, the method comprising:
receiving a PDF document;
inputting a number of pages to be printed on a single page; and
converting the received PDF document to printing data according to the input number of pages to print a corresponding number of pages of the PDF document on the single page.

7: The method of claim 6, further comprising:
generating parsing data by parsing the PDF document; and
reducing the parsing data by a ratio corresponding to the input number of pages.

8: A method of printing a plurality of pages on a single page in portable document format (PDF) direct printing, the method comprising:
receiving one or more PDF documents;
inputting a corresponding number of pages for each group of one or more groups of a plurality of pages from the one or more PDF documents to print each group of pages on a corresponding single page; and
converting the plurality of pages of the one or more received PDF documents to printing data according to the corresponding input number of pages of each group to print each group of pages on the corresponding single page.

9: The method of claim 8, further comprising:
generating parsing data by parsing the plurality of pages of the one or more PDF documents; and
reducing the parsing data by a ratio corresponding to the input number of pages for each group to be printed on the corresponding single page.

10: The method of claim 9, further comprising:
printing the converted printing data for each group of pages on the corresponding single page.

11: The method of claim 8, further comprising:
printing the converted printing data for each group of pages on the corresponding single page.

12: An apparatus to print a plurality of pages on a single page in portable document format (PDF) direct printing, the apparatus comprising:
a data input module to receive a PDF document;
a user interface to receive an input number of pages to be printed on a single page; and
a controller arranged to convert the received PDF document to printing data according to the input number of pages to print a corresponding number of pages of the PDF document on the single page.

13: The apparatus of claim 12, wherein the controller further comprises:
a PostScript converter to convert the parsing data to a PostScript language; and
an interpreter to generate an interpreted PostScript language by interpreting the PostScript language,
wherein the PostScript converter converts the parsing data to a PostScript language by reducing the parsing data by a ratio corresponding to the input number of pages.

14: An apparatus to print a plurality of pages on a single page in portable document format (PDF) direct printing, the apparatus comprising:
a data input module to receive one or more PDF documents;
a user interface to receive a corresponding input of a number of pages for each group of one or more groups of a plurality of pages from the one or more PDF documents to print each group of pages on a corresponding single page; and
a controller to convert the received pages of the one or more PDF documents to printing data, according to the corresponding input number of pages of each group, to print each group of pages on the corresponding single page.

15: The apparatus of claim 14, further comprising:
a printing module to print in PDF direct printing the printing data obtained from the controller according to the corresponding input number of pages of each group to print each group of pages on the corresponding single page.

16: The apparatus of claim 14, wherein the controller comprises:
a parser to generate parsing data by parsing the plurality of pages of the one or more PDF documents to be printed;
a PostScript converter to convert the parsing data to a PostScript language; and
an interpreter to generate an interpreted PostScript language by interpreting the PostScript language,
wherein the PostScript converter converts the parsing data to a PostScript language by reducing the parsing data by a ratio corresponding to the input number of pages for each group to be printed on the corresponding single page.

17: The apparatus of claim 16, further comprising:
a printing module to print in PDF direct printing the printing data obtained from the controller according to the corresponding input number of pages of each group to print each group of pages on the corresponding single page.
